(19) United States
(12) Patent Application Publication
(10) Pub. No.: US 2010/0176902 A1
(43) Pub. Date: Jul. 15, 2010

(54) Magnetic Drive System for a Switching Device

(75) Inventor: Ralf-Reiner Volkmar, Oldenburg i. H. (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/663,655

(22) PCT Filed: Jun. 2, 2008
(86) PCT No.: PCT/EP08/56751

§ 371 Date: Dec. 8, 2009

(30) Foreign Application Priority Data
Jun. 15, 2007 (DE) 10 2007 028 203.8

(51) Int. Cl. H01H 51/24

(52) U.S. Cl. 335/84

(57) ABSTRACT

A magnetic drive system for switchgear has a magnet yoke in which a solid armature made of a magnetic material is guided in a linearly displaceable manner between two opposing end positions. The magnetic drive system further has at least one permanent magnet for generating a magnetic flux in the magnet yoke and at least one coil by which the armature can be moved back and forth between the end positions thereof. The armature is provided with elongated hollow channels for preventing eddy current losses. So as not to excessively reduce the stability of the armature by the channels made therein, the channels in the armature are configured in a closed fashion on the circumference thereof.

The invention relates to a magnetic drive system for a switching device of the type specified in the precharacterizing clause of patent claim 1.

A bipolar drive system such as this is already known, for example, from DE 197 09 089 A1. The armature in this case is composed of a solid magnetic iron material which allows it to be manufactured at a lower cost than an armature composed of layers of electrical laminates, and it also frequently has longer long-term stability. In this context, the solid armature has the intrinsic disadvantage that, in comparison to armatures composed of layers of electrical laminates, more eddy current losses occur and the remanence is greater which, inter alia, makes it more difficult to release the switching contacts during switching processes. In order to reduce the eddy current losses, the armature is provided with elongated hollow channels which comprise narrow slots and extend in the forward-movement direction of the armature, and therefore in the direction of the magnetic lines of force. The slots which are provided on the narrow faces of the armature weaken the cuboid armature in this case over one-third of its cross-sectional width in each case, and over its entire length. Furthermore, a plurality of parallel slots are cut out alongside one another from the broad faces of the armature and do not extend over the entire length of the armature, but end at a distance from the end faces of the armature. However, the slots have a considerable adverse effect on the mechanical robustness of the armature overall. Provision is therefore made for the robustness of the armature to be further increased after introduction of the slots, by filling the slots with insulating material. However, in particular because these slots should be as narrow as possible, for technical reasons, the filling of the slots is technically correspondingly difficult and considerably increases the armature production costs.

In order to counter the greater remanence of the armature, it should be possible to adapt the junctions between the contact surface of the armature and the yoke laminates as required. Reducing the contact area admittedly leads to a better response in the sense of a shorter switching time, but this must be obtained at the expense of the disadvantage of a reduced armature holding force. Since, however, an excessively low armature holding force has a disadvantageous effect on the operational reliability of the magnetic drive system, the known drive system cannot comply with the design requirements for many applications.

The invention is therefore based on the object of further developing a magnetic drive system of the type specified in the precharacterizing clause of claim 1 in such a way that the robustness of the armature is not excessively reduced by its design to reduce the eddy current losses.

This object is achieved by the features of patent claim 1.

Advantageous refinements of the invention are the subject matter of the dependent claims.

The magnetic drive system according to the invention for a switching device has a magnet yoke in which a solid armature composed of magnetic material is guided such that it can move linearly between two opposite limit positions, and at least one permanent magnet for production of a magnetic flux in the magnet yoke, and at least one coil, by means of which the armature can be moved backward and forward between its limit positions, wherein the armature is provided with elongated channels in order to prevent eddy current losses, and the channels in the armature are closed all the way round on their circumference.

The arrangement of channels (hollow channels) which are closed all the way round in the armature results in a simple manner in the robustness of the armature being scarcely adversely affected. This avoids the need for the technically complex filling of the channels.

The channels which are incorporated in the armature preferably comprise holes with a relatively small hollow cross section. Holes such as these need not necessarily be circular but may also, for example, have an oval cross section. However, as far as possible, the hollow cross section should be configured such that there are no sharp corners on the circumferential wall which bounds the hollow cross section.

However, when holes are introduced retrospectively into the armature block, it is advantageous for the holes to be circular because they can then be produced at low cost by means of drills.

With respect to both the technical effect and from the production engineering point of view as well, it is advantageous for the holes in the armature actually to be through-holes. Alternatively, the holes may be in the form of blind holes, which are drilled from both side surfaces.

The technical effect of a gap in terms of reducing the eddy current losses can be achieved approximately by arranging a plurality of channels in a row in the armature a short distance apart to form a row of bore holes or a plurality of rows of holes. In this case, a plurality of rows of holes are expediently each aligned parallel to one another along a straight line.

It is particularly effective for those end faces of the armature block through which the armature guide rods pass to be connected via at least one row of holes or a plurality of parallel rows of holes, in particular two, three or four rows of holes, with these holes being through-holes which run parallel to the broad faces of the armature close to the hole for the armature guide rod. At least one further row of holes or a plurality of rows of holes, in particular two, three or four rows of holes, can be provided centrally between these rows of holes, extending along the center longitudinal plane of the armature, between its narrow faces.

A further technical improvement is achieved if the broad faces of the armature block are also perforated by a plurality of rows, largely of through-holes. In this case, two arrays of rows of holes can be arranged next to the lateral plane of the armature guide rod. If two armature guide rods are mounted in opposite blind holes in the armature, then an armature area which remains between the blind hole ends and is composed of solid material can additionally still be used for central arrangement of one through-hole.

The armature block, through which holes pass in all three spatial directions, ensures not only that the eddy current losses are reduced but also a considerable reduction in the remanence tendency. The remanence is reduced to an even greater extent if the opposing surfaces which interact with the stop surfaces of the armature are also each perforated by one row of holes, or in each case a plurality of rows of holes.

Overall, in comparison to the known system with slots as hollow channels, the magnet system has the advantage that the formation of eddy currents is impeded in all three axis directions, and is thus reduced. In this case, the operational reliability is maintained virtually without any restriction, since the holding force for the same total induction is reduced only insignificantly, and the remanent induction of the magnet circuit decreases at the same time.

The latter effect is essentially because the magnetic induction in the armature is only locally specifically increased into the saturation range, and the local permeability is thus reduced. Furthermore, the armature mass is reduced because of the numerous channels in the armature, thus resulting overall in less remanence associated with better dynamic characteristics of the armature and of the overall magnet system.

Further expedient refinements and advantages of the invention will become evident from the following description of one exemplary embodiment and with reference to the figures of the drawing, in which mutually corresponding components are provided with the same reference symbols, and in which:

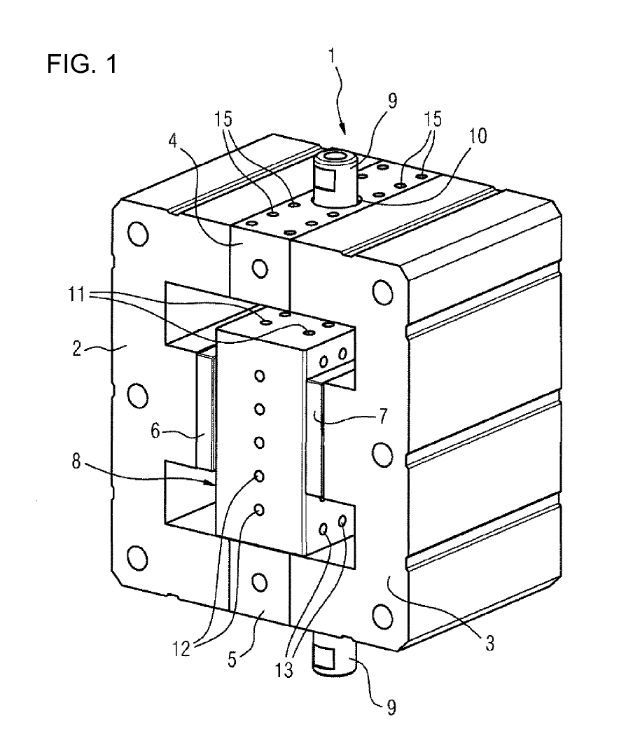

FIG. 1 shows a perspective oblique view of a supporting structure for a magnetic drive system,

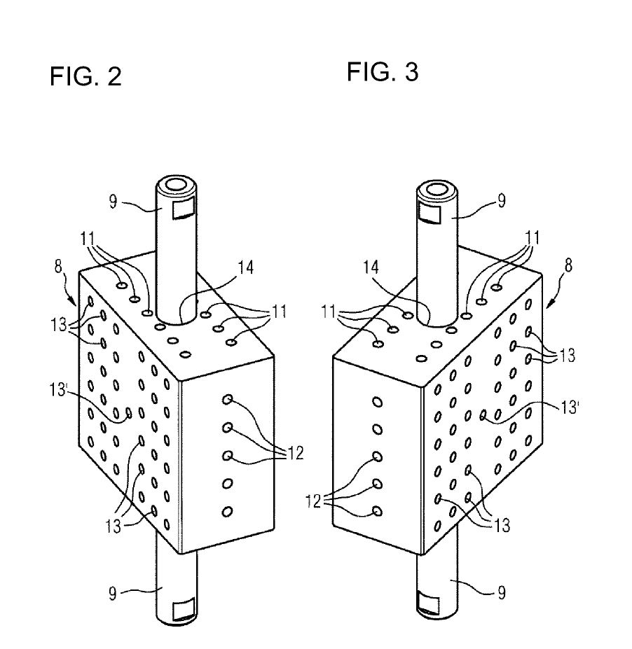

FIG. 2 shows a perspective individual view, obliquely from the left, of an armature of the supporting structure,

FIG. 3 shows a perspective individual view, obliquely from the right, of the armature of the supporting structure,

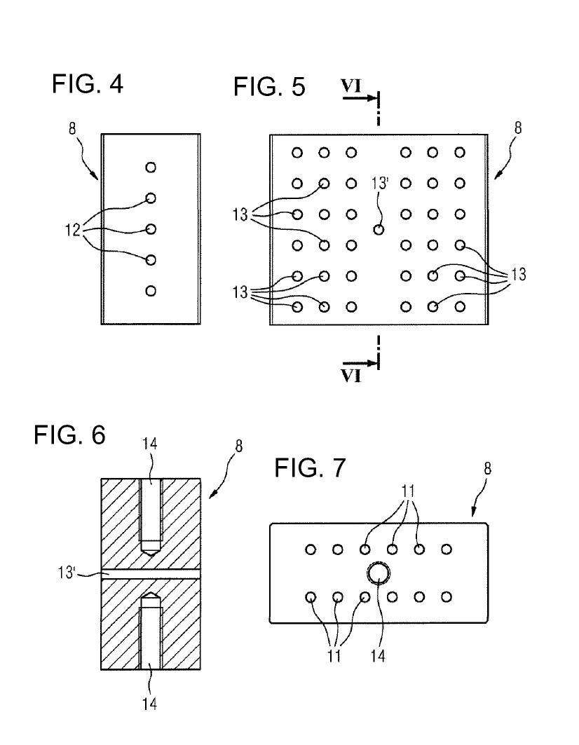

FIG. 4 shows a front view of a narrow face of the separate armature block,

FIG. 5 shows a front view of one broad face of the separate armature block,

FIG. 6 shows a section through the armature block along the section line VI-VI in FIG. 5, and

FIG. 7 shows a front view of one end face of the separate armature block.

FIG. 1 shows a supporting structure 1 of a permanent-magnet drive system, which is not illustrated in its totality, for the operation of a switching device. This structure 1 has a cuboid frame which comprises two magnet yokes 2 and 3 with two mounting plates 4 and 5 between them. The two magnet yokes 2 and 3 have mirror-image symmetry and, at each of the two ends, have yoke limbs which are angled through 90° thus creating an approximately U-shaped basic shape. The planar end surfaces of the yoke limbs of the magnet yokes 2 and 3 which face one another rest flat at the top on the facing side surface of the mounting plate 4 and at the bottom on the facing side surface of the mounting plate 5, with the corresponding yoke limbs being connected to one another via the mounting plates 4 and 5. A protruding pole limb projects from the central area between the yoke limbs from each of the magnet yokes 2 and 3, with the mutually opposite pole limbs facing one another, corresponding to the yoke limbs. Permanent magnets 6 and 7 in the form of plates are attached to the ends of the pole limbs which are opposite one another with a distance between them.

A cuboid armature 8 is located in the yoke frame between the plane-parallel permanent magnets 6 and 7 and at a short distance from them and, in the illustrated position, rests on the mounting plate 5. The armature 8 also has two armature guide rods 9 which project centrally from the upper face and the lower face, respectively, of the armature block and are arranged geometrically coaxially with respect to one another. The armature guide rods 9 pass through a bearing hole 10 in the respective mounting plate 4 or 5 associated with them, with little circumferential play, and an end area of them projects out of the bearing hole 10 in their mounting plate 4 or 5, as a result of which the armature 8 can be moved linearly in the vertical direction by means of the guide rods 9. In conjunction with the pole limbs and the yoke limbs, the yoke frame would also be provided with two coils, whose magnetic field would move the armature 8 to its upper limit position, with an appropriate polarity direction, after overcoming its adhesion to the mounting plate 5, in which upper limit position its forward movement would be limited by impacting on the lower face of the mounting plate 4. After reversal of the polarity direction of the magnetic field, it will once again be forced down, after overcoming the adhesion by magnetic forces, to the illustrated limit position onto the mounting plate 5, and will be held in the contact position. The method of operation of magnet drives such as these is known per se, and will therefore not be described any further here.

In this case, the magnet yokes 2 and 3 comprise a multiplicity of thin yoke laminates which are joined to form the illustrated, thick yoke laminate stack. In contrast, the armature 8 and the mounting plates 4 and 5 are composed of blocks of ferromagnetic material of a known type, in particular of an appropriate iron alloy.

In order to reduce the eddy current losses and the remenance of the armature 8 and of the mounting plates 4 and 5, a multiplicity of channels (hollow channels) 11, 12 and 13 are integrated in the solid block of the armature 8 and in this case have a corresponding diameter of 2 mm to 3 mm, with them all being in the form of through-holes and differing only in terms of their length, since they pass through the block of the armature 8 in different directions. Alternatively, the channels 11, 12 and 13 may also be in the form of blind holes, which are drilled from both side surfaces.

As can be seen more clearly in conjunction with FIGS. 2 and 3, the channels 11 originate from the upper end face of the armature 8, run parallel to the central longitudinal axis of the armature guide rods 9 and therefore at right angles to the planar end face until they open on the opposite end face. In this case, there are two rows, each having six channels 11, with the channels 11 in each of the two rows each being separated by a distance of about 4 mm from the adjacent channel 11. These rows run parallel to the long side edges of the end faces and on opposite sides of a blind hole 14 which is arranged centrally on the end face and has an internal thread into which the armature guide rod 9 is screwed. The channels 12 are arranged transversely with respect to these channels 11, originate from a narrow face of the armature 8 and open on the opposite narrow face of the armature 8. This total of five channels 12 forms a straight row which is arranged centrally between the long side edges of the narrow face, as can be seen without any doubt in conjunction with FIG. 4. However, these channels 12 therefore also run centrally between the two rows with the channels 11 and also pass through the plane on which the armature guide rods 9 are arranged. If the aim is to avoid any weakening of the hole wall of the blind holes 14, the channels 12 can therefore alternatively also be in the form of blind holes and can end at a distance before the blind hole 14. Blind holes such as these as channels 12 should then as far as possible end at the same distance from the blind hole 14 as the lateral distance between the channels 11 on the end face of the armature 8. This distance can be seen well in the front plan view shown in FIG. 7. However, in this case, the channels 12 would have to be drilled from the opposite end faces, which would result in corresponding additional effort for production of the armature 8.

The channels 13 are likewise introduced transversely with respect to the channels 11, but with a considerably greater number of them, and they all extend at right angles to the longitudinal center plane of the armature 8. In this case, the channels 13 originate from one broad face of the armature 8 and open into the opposite broad face. The hole pattern on the broad face in this case comprises two rectangular hole arrays which comprise three parallel rows of six hollow channels 13 each, with the hollow channels 13 in the row and at the side being at a corresponding distance from one another. These hole arrays are located on both sides of a central area of the armature 8, in which the armature guide rods 9 are arranged.

An individual channel 13′ is additionally arranged centrally between the two hole arrays composed of hollow channels 13, and likewise forms a through-hole connecting the broad faces. As can be seen from the front view shown in FIG. 5 in conjunction with the sectional illustration shown in FIG. 6, the hollow channel 13′ in this case passes through a solid material area of the armature block which remains between the ends of the two blind holes 14. The channel 13′ therefore only insignificantly affects the robustness of the armature 8.

In addition to the channels in the armature 8, channels 15 are also located in the mounting plates 4 and 5, and extend parallel to the axes of the channels 11. Of the channels (hollow channels) 15, there are two rows of six channels 15 each, which are preferably arranged congruent to the channels 11 in the armature 8.

### LIST OF REFERENCE SYMBOLS

1 Structure
2 Magnet yoke
3 Magnet yoke
4 Mounting plate
5 Mounting plate
6 Permanent magnet
7 Permanent magnet
8 Armature
9 Armature guide rods
10 Bearing hole
11 Channel (hollow channel) armature
12 Channel (hollow channel) armature
13 Channel (hollow channel) armature
13′ Channel (hollow channel) armature
14 Blind hole
15 Channel (hollow channel) mounting plate

1-11. (canceled)

12. A magnetic drive system for a switching device, comprising:
a magnet yoke;
a solid armature composed of a magnetic material guided in said magnet yoke such that said solid armature can move linearly between two opposite limit positions, said solid armature having elongated channels formed therein for preventing eddy current losses and said channels being closed all the way around on a circumference;
at least one permanent magnet for producing a magnetic flux in said magnet yoke; and
at least one coil, by means of which said armature can be moved backward and forward between said two opposite limit positions.

13. The magnetic drive system according to claim 12, wherein said channels in said armature include holes.

14. The magnetic drive system according to claim 13, wherein said channels in said armature are one of through-holes and blind holes.

15. The magnetic drive system according to claim 12, wherein a plurality of said channels, which are closed all the way round, in the magnetic drive system are disposed in a row to form a row of holes.

16. The magnetic drive system according to claim 15, wherein said plurality of said channels form a plurality of rows of said holes which run parallel to one another.

17. The magnetic drive system according to claim 16, wherein said armature is a cuboid armature having armature guide rods and end faces through which said armature guide rods pass, said end faces have at least one row of said holes of said channels.

18. The magnetic drive system according to claim 13, wherein a configuration of said channels passes through said armature transversely with respect to its forward-movement direction.

19. The magnetic drive system according to claim 18, wherein said configuration of said channels has at least one row of said channels running centrally along narrow faces of said armature.

20. The magnetic drive system according to claim 18, wherein said configuration of said channels has two hole arrays which are disposed at a distance from one another at a side on broad faces of said armature and each contain a plurality of rows of said holes formed by said channels.

21. The magnetic drive system according to claim 18, wherein:
said armature has blind holes formed therein for holding said armature guide rods; and
said armature has broad faces connected to one another centrally via a central channel formed in a solid material of said armature and runs between said blind holes for holding said armature guide rods.

22. The magnetic drive system according to claim 12, wherein:
said armature has stop surfaces; and
said magnetic yoke has opposing surfaces which interact with said stop surfaces of said armature, said opposing surfaces having at least one row of holes with said channels formed therein.
